(19) United States
(12) Patent Application Publication
(10) Pub. No.: US 2003/0046474 A1
(43) Pub. Date: Mar. 6, 2003

(54) Mixed semantic storage I/O

(75) Inventors: David F. Craddock, New Paltz, NY (US); Charles Scott Graham, Rochester, MO (US); Ian David Judd, Otterbourne (GB); Renato John Recio, Austin, TX (US)

Correspondence Address: Duke W. Yee, Carstens, Yee & Cahoon, LLP, P.O. Box 802334, Dallas, TX, 75380, US

(73) Assignee: International Business Machines Corporation, Armonk, NY

(21) Appl. No.: 09/886,191

(22) Filed: Jun. 21, 2001

(51) Int. Cl. G06F 13/36

(52) U.S. Cl. 710/308

(57) ABSTRACT

A mechanism for initiating and completing one or more I/O transactions using channel and memory semantic messages is disclosed. Channel semantic messages are messages that are simply packetized and transmitted. Memory semantic messages are transmitted by means of a remote direct memory access (RDMA) operation; they are more akin to a memory copy than the simple transmission of a message.

### BACKGROUND OF THE INVENTION

1. Technical Field

The present invention generally relates to communication protocols between a host computer and an input/output (I/O) device. More specifically, the present invention provides a method by which an I/O device can communicate over a network to a general purpose processing node (a.k.a. host, host computer) using a mix of channel and memory semantic messages.

2. Description of Related Art

In a System Area Network (SAN), the hardware provides a message passing mechanism that can be used for Input/Output devices (I/O) and interprocess communications between general computing nodes (IPC). Processes executing on devices access SAN message passing hardware by posting send/receive messages to send/receive work queues on a SAN channel adapter (CA). These processes also are referred to as “consumers”.

The send/receive work queues (WQ) are assigned to a consumer as a queue pair (QP). The messages can be sent over five different transport types: Reliable Connected (RC), Reliable datagram (RD), Unreliable Connected (UC), Unreliable Datagram (UD), and Raw Datagram (RawD). Consumers retrieve the results of these messages from a completion queue (CQ) through SAN send and receive work completion (WC) queues. The source channel adapter takes care of segmenting outbound messages and sending them to the destination. The destination channel adapter takes care of reassembling inbound messages and placing them in the memory space designated by the destination's consumer.

Two channel adapter types are present in nodes of the SAN fabric, a host channel adapter (HCA) and a target channel adapter (TCA). The host channel adapter is used by general purpose computing nodes to access the SAN fabric. Consumers use SAN verbs to access host channel adapter functions. The software that interprets verbs and directly accesses the channel adapter is known as the channel interface (CI).

Target channel adapters (TCA) are used by nodes that are the subject of messages sent from host channel adapters. The target channel adapters serve a similar function as that of the host channel adapters in providing the target node an access point to the SAN fabric.

To make efficient use of storage devices within a SAN, however, a consumer protocol is needed to attach advanced function storage subsystems to general-purpose computers.

### SUMMARY OF THE INVENTION

The present invention provides a method, computer program product, and distributed data processing system for processing storage I/O in a system area network (SAN). The distributed data processing system comprises end nodes, switches, routers, and links interconnecting the components. The end nodes use send and receive pairs to transmit and receive messages. The end nodes segment the message into packets and transmit the packets over the links. The switches and routers interconnect the end nodes and route the packets to the appropriate end nodes. The end nodes reassemble the packets into a message at the destination. An I/O transaction represents a unit of I/O work and typically contains multiple messages. An example I/O transaction is a read from a specific disk sector into a specific host memory location. I/O transactions are typically initiated by a host consumer, but can also be initiated by an I/O device. The present invention provides a mechanism for initiating and completing one or more I/O transactions using channel and memory semantic messages. Channel semantic messages are messages that are simply packetized and transmitted. Memory semantic messages are transmitted by means of a remote direct memory access (RDMA) operation; they are more akin to a memory copy than the simple transmission of a message.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a diagram of a distributed computer system is illustrated in accordance with a preferred embodiment of the present invention;

FIG. 2 is a functional block diagram of a host processor node in accordance with a preferred embodiment of the present invention;

FIG. 3A is a diagram of a host channel adapter in accordance with a preferred embodiment of the present invention;

FIG. 3B is a diagram of a switch in accordance with a preferred embodiment of the present invention;

FIG. 3C is a diagram of a router in accordance with a preferred embodiment of the present invention;

FIG. 4 is a diagram illustrating processing of work requests in accordance with a preferred embodiment of the present invention;

FIG. 5 is a diagram illustrating a portion of a distributed computer system in accordance with a preferred embodiment of the present invention in which a reliable connection service is used;

FIG. 6 is a diagram illustrating a portion of a distributed computer system in accordance with a preferred embodiment of the present invention in which reliable datagram service connections are used;

FIG. 7 is an illustration of a data packet in accordance with a preferred embodiment of the present invention;

FIG. 8 is a diagram illustrating a portion of a distributed computer system in accordance with a preferred embodiment of the present invention;

FIG. 9 is a diagram illustrating the network addressing used in a distributed networking system in accordance with the present invention;

FIG. 10 is a diagram illustrating a portion of a distributed computing system in accordance with a preferred embodiment of the present invention in which the structure of SAN fabric subnets is illustrated;

FIG. 11 is a diagram of a layered communication architecture used in a preferred embodiment of the present invention;

FIG. 12 is a diagram showing the flow of Communication Management packets to establish a connection and exchange private data in a preferred embodiment of the present invention;

FIG. 13 is a diagram of the operation of an upper-level mixed semantic write protocol in accordance with a preferred embodiment of the present invention;

FIG. 14 is a diagram of the operation of an upper-level mixed semantic read protocol in accordance with a preferred embodiment of the present invention; and

FIG. 15 is a flowchart representation of the operation of an upper-level mixed semantic input/output protocol in accordance with a preferred embodiment of the present invention.

### DETAILED DESCRIPTION OF THE PREFERRED EMBODIMENT

The present invention provides a distributed computing system having end nodes, switches, routers, and links interconnecting these components. Each end node uses send and receive queue pairs to transmit and receive messages. The end nodes segment the message into packets and transmit the packets over the links. The switches and routers interconnect the end nodes and route the packets to the appropriate end node. The end nodes reassemble the packets into a message at the destination.

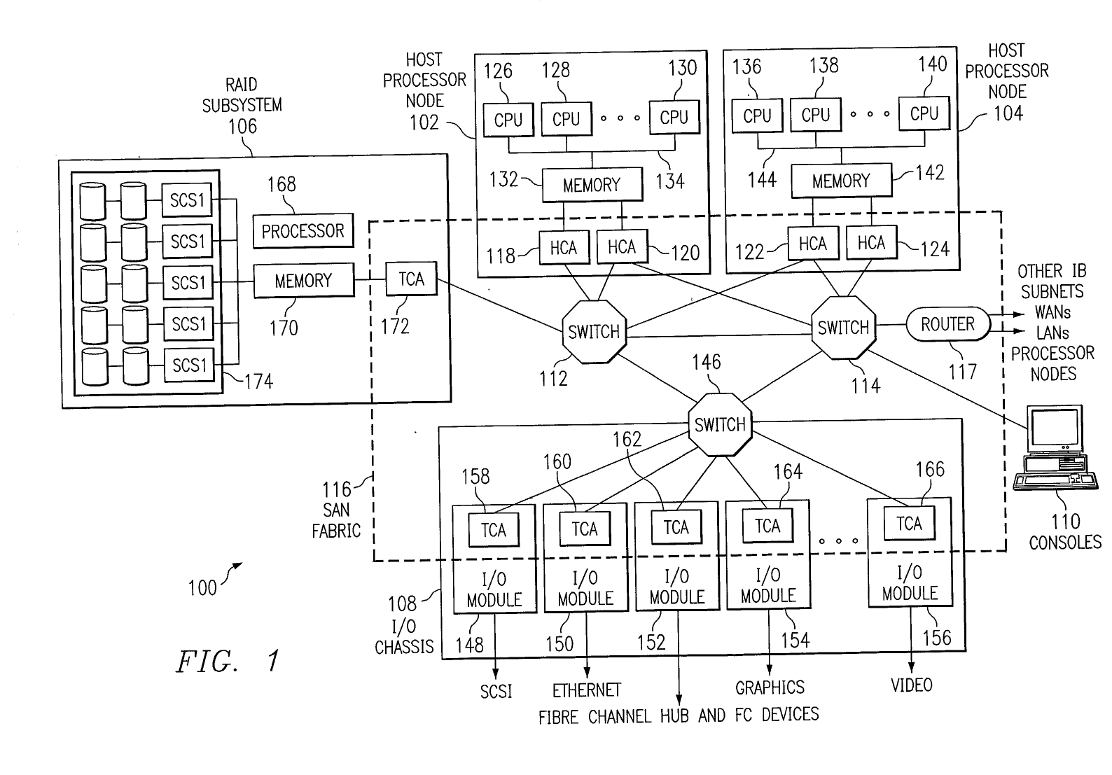

With reference now to the figures and in particular with reference to FIG. 1, a diagram of a distributed computer system is illustrated in accordance with a preferred embodiment of the present invention. The distributed computer system represented in FIG. 1 takes the form of a system area network (SAN) 100 and is provided merely for illustrative purposes, and the embodiments of the present invention described below can be implemented on computer systems of numerous other types and configurations. For example, computer systems implementing the present invention can range from a small server with one processor and a few input/output (I/O) adapters to massively parallel supercomputer systems with hundreds or thousands of processors and thousands of I/O adapters. Furthermore, the present invention can be implemented in an infrastructure of remote computer systems connected by an internet or intranet.

SAN 100 is a high-bandwidth, low-latency network interconnecting nodes within the distributed computer system. A node is any component attached to one or more links of a network and forming the origin and/or destination of messages within the network. In the depicted example, SAN 100 includes nodes in the form of host processor node 102, host processor node 104, redundant array independent disk (RAID) subsystem node 106, and I/O chassis node 108. The nodes illustrated in FIG. 1 are for illustrative purposes only, as SAN 100 can connect any number and any type of independent processor nodes, I/O adapter nodes, and I/O device nodes. Any one of the nodes can function as an endnode, which is herein defined to be a device that originates or finally consumes messages or packets in SAN 100.

In one embodiment of the present invention, an error handling mechanism in distributed computer systems is present in which the error handling mechanism allows for reliable connection or reliable datagram communication between end nodes in a distributed computing system, such as SAN 100.

A message, as used herein, is an application-defined unit of data exchange, which is a primitive unit of communication between cooperating processes. A packet is one unit of data encapsulated by networking protocol headers and/or trailers. The headers generally provide control and routing information for directing the packet through SAN 100. The trailer generally contains control and cyclic redundancy check (CRC) data for ensuring packets are not delivered with corrupted contents.

SAN 100 contains the communications and management infrastructure supporting both I/O and interprocessor communications (IPC) within a distributed computer system. The SAN 100 shown in FIG. 1 includes a switched communications fabric 116, which allows many devices to concurrently transfer data with high-bandwidth and low latency in a secure, remotely managed environment. End-nodes can communicate over multiple ports and utilize multiple paths through the SAN fabric. The multiple ports and paths through the SAN shown in FIG. 1 can be employed for fault tolerance and increased bandwidth data transfers.

The SAN 100 in FIG. 1 includes switch 112, switch 114, switch 146, and router 117. A switch is a device that connects multiple links together and allows routing of packets from one link to another link within a subnet using a small header Destination Local Identifier (DLID) field. A router is a device that connects multiple subnets together and is capable of routing frames from one link in a first subnet to another link in a second subnet using a large header Destination Globally Unique Identifier (DGUID).

In one embodiment, a link is a full duplex channel between any two network fabric elements, such as endnodes, switches, or routers. Example suitable links include, but are not limited to, copper cables, optical cables, and printed circuit copper traces on backplanes and printed circuit boards.

For reliable service types, endnodes, such as host processor endnodes and I/O adapter endnodes, generate request packets and return acknowledgment packets. Switches and routers pass packets along, from the source to the destination. Except for the variant CRC trailer field, which is updated at each stage in the network, switches pass the packets along unmodified. Routers update the variant CRC trailer field and modify other fields in the header as the packet is routed.

In SAN 100 as illustrated in FIG. 1, host processor node 102, host processor node 104, and I/O chassis 108 include at least one channel adapter (CA) to interface to SAN 100. In one embodiment, each channel adapter is an endpoint that implements the channel adapter interface in sufficient detail to source or sink packets transmitted on SAN fabric 100. Host processor node 102 contains channel adapters in the form of host channel adapter 118 and host channel adapter 120. Host processor node 104 contains host channel adapter 122 and host channel adapter 124. Host processor node 102 also includes central processing units 126-130 and a memory 132 interconnected by bus system 134. Host processor node 104 similarly includes central processing units 136-140 and a memory 142 interconnected by a bus system 144.

Host channel adapters 118 and 120 provide a connection to switch 112 while host channel adapters 122 and 124 provide a connection to switches 112 and 114.

In one embodiment, a host channel adapter is implemented in hardware. In this implementation, the host channel adapter hardware offloads much of central processing unit and I/O adapter communication overhead. This hardware implementation of the host channel adapter also permits multiple concurrent communications over a switched network without the traditional overhead associated with communicating protocols. In one embodiment, the host channel adapters and SAN 100 in FIG. 1 provide the I/O and interprocessor communications (IPC) consumers of the distributed computer system with zero processor-copy data transfers without involving the operating system kernel process, and employs hardware to provide reliable, fault tolerant communications.

As indicated in FIG. 1, router 117 is coupled to wide area network (WAN) and/or local area network (LAN) connections to other hosts or other routers.

The I/O chassis 108 in FIG. 1 includes an I/O switch 146 and multiple I/O modules 148-156. In these examples, the I/O modules take the form of adapter cards. Example adapter cards illustrated in FIG. 1 include a SCSI adapter card for I/O module 148; an adapter card to fiber channel hub and fiber channel-arbitrated loop (FC-AL) devices for I/O module 152; an ethernet adapter card for I/O module 150; a graphics adapter card for I/O module 154; and a video adapter card for I/O module 156. Any known type of adapter card can be implemented. I/O adapters also include a switch in the I/O adapter backplane to couple the adapter cards to the SAN fabric. These modules contain target channel adapters 158-166.

In this example, RAID subsystem node 106 in FIG. 1 includes a processor 168, a memory 170, a target channel adapter (TCA) 172, and multiple redundant and/or striped storage disk unit 174. Target channel adapter 172 can be a fully functional host channel adapter.

SAN 100 handles data communications for I/O and interprocessor communications. SAN 100 supports high-bandwidth and scalability required for I/O and also supports the extremely low latency and low CPU overhead required for interprocessor communications. User clients can bypass the operating system kernel process and directly access network communication hardware, such as host channel adapters, which enable efficient message passing protocols. SAN 100 is suited to current computing models and is a building block for new forms of I/O and computer cluster communication. Further, SAN 100 in FIG. 1 allows I/O adapter nodes to communicate among themselves or communicate with any or all of the processor nodes in a distributed computer system. With an I/O adapter attached to the SAN 100, the resulting I/O adapter node has substantially the same communication capability as any host processor node in SAN 100.

In one embodiment, the SAN 100 shown in FIG. 1 supports channel semantics and memory semantics. Channel semantics is sometimes referred to as send/receive or push communication operations. Channel semantics are the type of communications employed in a traditional I/O channel where a source device pushes data and a destination device determines a final destination of the data. In channel semantics, the packet transmitted from a source process specifies a destination processes' communication port, but does not specify where in the destination processes' memory space the packet will be written. Thus, in channel semantics, the destination process pre-allocates where to place the transmitted data.

In memory semantics, a source process directly reads or writes the virtual address space of a remote node destination process. The remote destination process need only communicate the location of a buffer for data, and does not need to be involved in the transfer of any data. Thus, in memory semantics, a source process sends a data packet containing the destination buffer memory address of the destination process. In memory semantics, the destination process previously grants permission for the source process to access its memory.

Channel semantics and memory semantics are typically both necessary for I/O and interprocessor communications. A typical I/O operation employs a combination of channel and memory semantics. In an illustrative example I/O operation of the distributed computer system shown in FIG. 1, a host processor node, such as host processor node 102, initiates an I/O operation by using channel semantics to send a disk write command to a disk I/O adapter, such as RAID subsystem target channel adapter (TCA) 172. The disk I/O adapter examines the command and uses memory semantics to read the data buffer directly from the memory space of the host processor node. After the data buffer is read, the disk I/O adapter employs channel semantics to push an I/O completion message back to the host processor node.

In one exemplary embodiment, the distributed computer system shown in FIG. 1 performs operations that employ virtual addresses and virtual memory protection mechanisms to ensure correct and proper access to all memory. Applications running in such a distributed computer system are not required to use physical addressing for any operations.

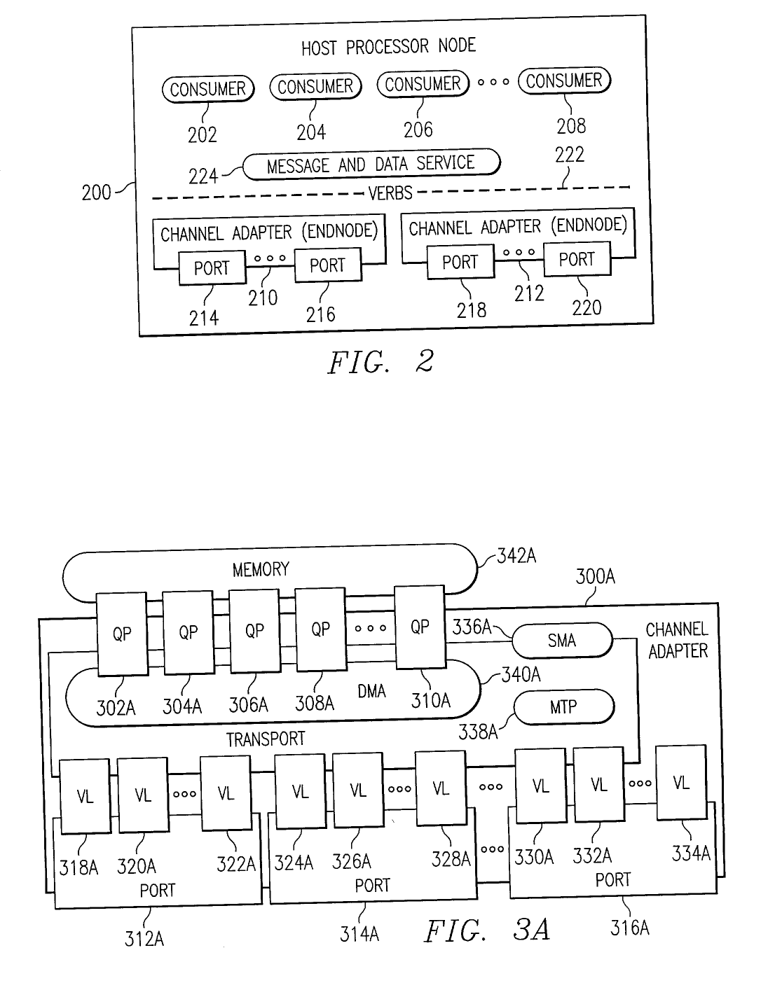

Turning next to FIG. 2, a functional block diagram of a host processor node is depicted in accordance with a preferred embodiment of the present invention. Host processor node 200 is an example of a host processor node, such as host processor node 102 in FIG. 1. In this example, host processor node 200 shown in FIG. 2 includes a set of consumers 202-208, which are processes executing on host processor node 200. Host processor node 200 also includes channel adapter 210 and channel adapter 212. Channel adapter 210 contains ports 214 and 216 while channel adapter 212 contains ports 218 and 220. Each port connects to a link. The ports can connect to one SAN subnet or multiple SAN subnets, such as SAN 100 in FIG. 1. In these examples, the channel adapters take the form of host channel adapters.

Consumers 202-208 transfer messages to the SAN via the verbs interface 222 and message and data service 224. A verbs interface is essentially an abstract description of the functionality of a host channel adapter. An operating system may expose some or all of the verb functionality through its programming interface. Basically, this interface defines the behavior of the host. Additionally, host processor node 200 includes a message and data service 224, which is a higher-level interface than the verb layer and is used to process messages and data received through channel adapter 210 and channel adapter 212. Message and data service 224 provides an interface to consumers 202-208 to process messages and other data.

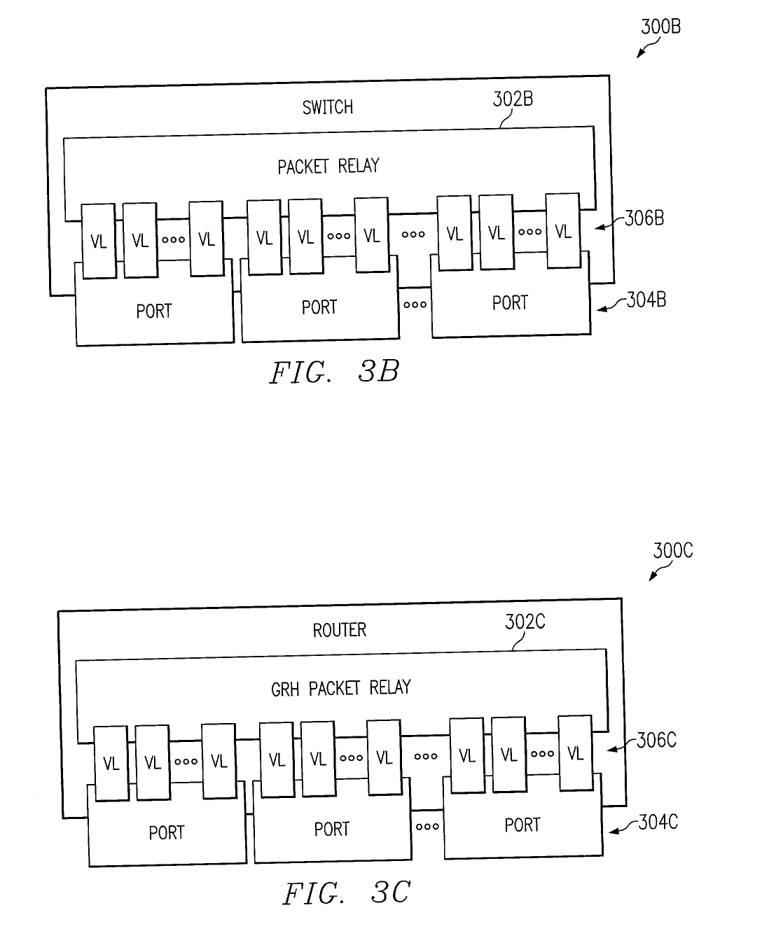

With reference now to FIG. 3A, a diagram of a host channel adapter is depicted in accordance with a preferred embodiment of the present invention. Host channel adapter 300A shown in FIG. 3A includes a set of queue pairs (QPs) 302A-310A, which are used to transfer messages to the host channel adapter ports 312A-316A. Buffering of data to host channel adapter ports 312A-316A is channeled through virtual lanes (VL) 318A-334A where each VL has its own flow control. Subnet manager configures channel adapters with the local addresses for each physical port, i.e., the port's LID. Subnet manager agent (SMA) 336A is the entity that communicates with the subnet manager for the purpose of configuring the channel adapter. Memory translation and protection (MTP) 338A is a mechanism that translates virtual addresses to physical addresses and validates access rights. Direct memory access (DMA) 340A provides for direct memory access operations using memory 342A with respect to queue pairs 302A-310A.

A single channel adapter, such as the host channel adapter 300A shown in FIG. 3A, can support thousands of queue pairs. By contrast, a target channel adapter in an I/O adapter typically supports a much smaller number of queue pairs. Each queue pair consists of a send work queue (SWQ) and a receive work queue. The send work queue is used to send channel and memory semantic messages. The receive work queue receives channel semantic messages. A consumer calls an operating-system specific programming interface, which is herein referred to as verbs, to place work requests (WRs) onto a work queue.

FIG. 3B depicts a switch 300B in accordance with a preferred embodiment of the present invention. Switch 300B includes a packet relay 302B in communication with a number of ports 304B through virtual lanes such as virtual lane 306B. Generally, a switch such as switch 300B can route packets from one port to any other port on the same switch.

Similarly, FIG. 3C depicts a router 300C according to a preferred embodiment of the present invention. Router 300C includes a packet relay 302C in communication with a number of ports 304C through virtual lanes such as virtual lane 306C. Like switch 300B, router 300C will generally be able to route packets from one port to any other port on the same router.

Channel adapters, switches, and routers employ multiple virtual lanes within a single physical link. As illustrated in FIGS. 3A, 3B, and 3C, physical ports connect endnodes, switches, and routers to a subnet. Packets injected into the SAN fabric follow one or more virtual lanes from the packet's source to the packet's destination. The virtual lane that is selected is mapped from a service level associated with the packet. At any one time, only one virtual lane makes progress on a given physical link. Virtual lanes provide a technique for applying link level flow control to one virtual lane without affecting the other virtual lanes. When a packet on one virtual lane blocks due to contention, quality of service (QoS), or other considerations, a packet on a different virtual lane is allowed to make progress.

Virtual lanes are employed for numerous reasons, some of which are as follows: Virtual lanes provide QoS. In one example embodiment, certain virtual lanes are reserved for high priority or isochronous traffic to provide QoS.

Virtual lanes provide deadlock avoidance. Virtual lanes allow topologies that contain loops to send packets across all physical links and still be assured the loops won't cause back pressure dependencies that might result in deadlock.

Virtual lanes alleviate head-of-line blocking. When a switch has no more credits available for packets that utilize a given virtual lane, packets utilizing a different virtual lane that has sufficient credits are allowed to make forward progress.

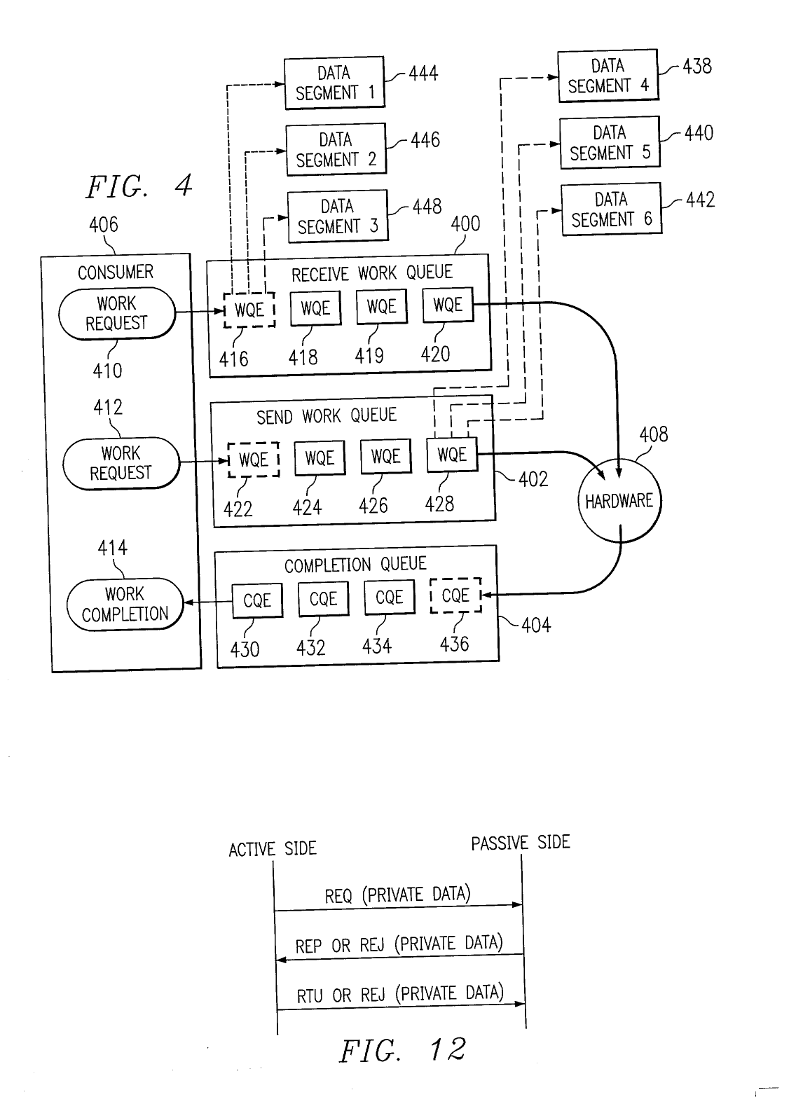

With reference now to FIG. 4, a diagram illustrating processing of work requests is depicted in accordance with a preferred embodiment of the present invention. In FIG. 4, a receive work queue 400, send work queue 402, and completion queue 404 are present for processing requests from and for consumer 406. These requests from consumer 402 are eventually sent to hardware 408. In this example, consumer 406 generates work requests 410 and 412 and receives work completion 414. As shown in FIG. 4, work requests placed onto a work queue are referred to as work queue elements (WQEs).

Send work queue 402 contains work queue elements (WQEs) 422-428, describing data to be transmitted on the SAN fabric. Receive work queue 400 contains work queue elements (WQEs) 416-420, describing where to place incoming channel semantic data from the SAN fabric. A work queue element is processed by hardware 408 in the host channel adapter.

The verbs also provide a mechanism for retrieving completed work from completion queue 404. As shown in FIG. 4, completion queue 404 contains completion queue elements (CQEs) 430-436. Completion queue elements contain information about previously completed work queue elements. Completion queue 404 is used to create a single point of completion notification for multiple queue pairs. A completion queue element is a data structure on a completion queue. This element describes a completed work queue element. The completion queue element contains sufficient information to determine the queue pair and specific work queue element that completed. A completion queue context is a block of information that contains pointers to, length, and other information needed to manage the individual completion queues.

Example work requests supported for the send work queue 402 shown in FIG. 4 are as follows. A send work request is a channel semantic operation to push a set of local data segments to the data segments referenced by a remote node's receive work queue element. For example, work queue element 428 contains references to data segment 4 438, data segment 5 440, and data segment 6 442. Each of the send work request's data segments contains part of a virtually contiguous memory region. The virtual addresses used to reference the local data segments are in the address context of the process that created the local queue pair.

A remote direct memory access (RDMA) read work request provides a memory semantic operation to read a virtually contiguous memory space on a remote node. A memory space can either be a portion of a memory region or portion of a memory window. A memory region references a previously registered set of virtually contiguous memory addresses defined by a virtual address and length. A memory window references a set of virtually contiguous memory addresses that have been bound to a previously registered region.

The RDMA Read work request reads a virtually contiguous memory space on a remote endnode and writes the data to a virtually contiguous local memory space. Similar to the send work request, virtual addresses used by the RDMA Read work queue element to reference the local data segments are in the address context of the process that created the local queue pair. The remote virtual addresses are in the address context of the process owning the remote queue pair targeted by the RDMA Read work queue element.

A RDMA Write work queue element provides a memory semantic operation to write a virtually contiguous memory space on a remote node. The RDMA Write work queue element contains a scatter list of local virtually contiguous memory spaces and the virtual address of the remote memory space into which the local memory spaces are written.

A RDMA FetchOp work queue element provides a memory semantic operation to perform an atomic operation on a remote word. The RDMA FetchOp work queue element is a combined RDMA Read, Modify, and RDMA Write operation. The RDMA FetchOp work queue element can support several read-modify-write operations, such as Compare and Swap if equal.

A bind (unbind) remote access key (R_Key) work queue element provides a command to the host channel adapter hardware to modify (destroy) a memory window by associating (disassociating) the memory window to a memory region. The R_Key is part of each RDMA access and is used to validate that the remote process has permitted access to the buffer.

In one embodiment, receive work queue 400 shown in FIG. 4 only supports one type of work queue element, which is referred to as a receive work queue element. The receive work queue element provides a channel semantic operation describing a local memory space into which incoming send messages are written. The receive work queue element includes a scatter list describing several virtually contiguous memory spaces. For example, work queue element 416 in receive work queue 400 references data segment 1 444, data segment 2 446, and data segment 448. An incoming send message is written to these memory spaces. The virtual addresses are in the address context of the process that created the local queue pair.

For interprocessor communications, a user-mode software process transfers data through queue pairs directly from where the buffer resides in memory. In one embodiment, the transfer through the queue pairs bypasses the operating system and consumes few host instruction cycles. Queue pairs permit zero processor-copy data transfer with no operating system kernel involvement. The zero processor-copy data transfer provides for efficient support of high-bandwidth and low-latency communication.

When a queue pair is created, the queue pair is set to provide a selected type of transport service. In one embodiment, a distributed computer system implementing the present invention supports four types of transport services: reliable, unreliable, reliable datagram, and unreliable datagram connection service.

Reliable and Unreliable connected services associate a local queue pair with one and only one remote queue pair. Connected services require a process to create a queue pair for each process that is to communicate with over the SAN fabric. Thus, if each of N host processor nodes contain P processes, and all P processes on each node wish to communicate with all the processes on all the other nodes, each host processor node requires P²×(N−1) queue pairs. Moreover, a process can connect a queue pair to another queue pair on the same host channel adapter.

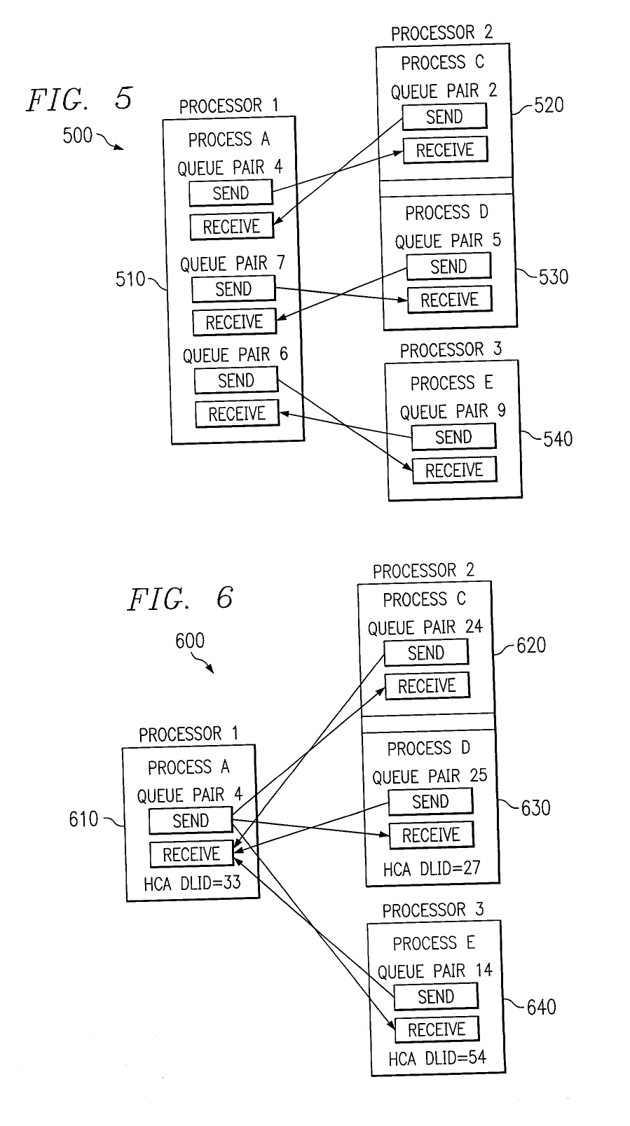

A portion of a distributed computer system employing a reliable connection service to communicate between distributed processes is illustrated generally in FIG. 5. The distributed computer system 500 in FIG. 5 includes a host processor node 1, a host processor node 2, and a host processor node 3. Host processor node 1 includes a process A 510. Host processor node 2 includes a process C 520 and a process D 530. Host processor node 3 includes a process E 540.

Host processor node 1 includes queue pairs 4, 6 and 7, each having a send work queue and receive work queue. Host processor node 3 has a queue pair 9 and host processor node 2 has queue pairs 2 and 5. The reliable connection service of distributed computer system 500 associates a local queue pair with one an only one remote queue pair. Thus, the queue pair 4 is used to communicate with queue pair 2; queue pair 7 is used to communicate with queue pair 5; and queue pair 6 is used to communicate with queue pair 9.

A WQE placed on one send queue in a reliable connection service causes data to be written into the receive memory space referenced by a Receive WQE of the connected queue pair. RDMA operations operate on the address space of the connected queue pair.

In one embodiment of the present invention, the reliable connection service is made reliable because hardware maintains sequence numbers and acknowledges all packet transfers. A combination of hardware and SAN driver software retries any failed communications. The process client of the queue pair obtains reliable communications even in the presence of bit errors, receive underruns, and network congestion. If alternative paths exist in the SAN fabric, reliable communications can be maintained even in the presence of failures of fabric switches, links, or channel adapter ports.

In addition, acknowledgements may be employed to deliver data reliably across the SAN fabric. The acknowledgement may, or may not, be a process level acknowledgement, i.e. an acknowledgement that validates that a receiving process has consumed the data. Alternatively, the acknowledgement may be one that only indicates that the data has reached its destination.

Reliable datagram service associates a local end-to-end (EE) context with one and only one remote end-to-end context. The reliable datagram service permits a client process of one queue pair to communicate with any other queue pair on any other remote node. At a receive work queue, the reliable datagram service permits incoming messages from any send work queue on any other remote node.

The reliable datagram service greatly improves scalability because the reliable datagram service is connectionless. Therefore, an endnode with a fixed number of queue pairs can communicate with far more processes and endnodes with a reliable datagram service than with a reliable connection transport service. For example, if each of N host processor nodes contain P processes, and all P processes on each node wish to communicate with all the processes on all the other nodes, the reliable connection service requires P²×(N−1) queue pairs on each node. By comparison, the connectionless reliable datagram service only requires P queue pairs+(N−1) EE contexts on each node for exactly the same communications.

A portion of a distributed computer system employing a reliable datagram service to communicate between distributed processes is illustrated in FIG. 6. The distributed computer system 600 in FIG. 6 includes a host processor node 1, a host processor node 2, and a host processor node 3. Host processor node 1 includes a process A 610 having a queue pair 4. Host processor node 2 has a process C 620 having a queue pair 24 and a process D 630 having a queue pair 25. Host processor node 3 has a process E 640 having a queue pair 14.

In the reliable datagram service implemented in the distributed computer system 600, the queue pairs are coupled in what is referred to as a connectionless transport service. For example, a reliable datagram service couples queue pair 4 to queue pairs 24, 25 and 14. Specifically, a reliable datagram service allows queue pair 4's send work queue to reliably transfer messages to receive work queues in queue pairs 24, 25 and 14. Similarly, the send queues of queue pairs 24, 25, and 14 can reliably transfer messages to the receive work queue in queue pair 4.

In one embodiment of the present invention, the reliable datagram service employs sequence numbers and acknowledgements associated with each message frame to ensure the same degree of reliability as the reliable connection service. End-to-end (EE) contexts maintain end-to-end specific state to keep track of sequence numbers, acknowledgements, and time-out values. The end-to-end state held in the EE contexts is shared by all the connectionless queue pairs communication between a pair of endnodes. Each endnode requires at least one EE context for every endnode it wishes to communicate with in the reliable datagram service (e.g., a given endnode requires at least N EE contexts to be able to have reliable datagram service with N other endnodes).

The unreliable datagram service is connectionless. The unreliable datagram service is employed by management applications to discover and integrate new switches, routers, and endnodes into a given distributed computer system. The unreliable datagram service does not provide the reliability guarantees of the reliable connection service and the reliable datagram service. The unreliable datagram service accordingly operates with less state information maintained at each endnode.

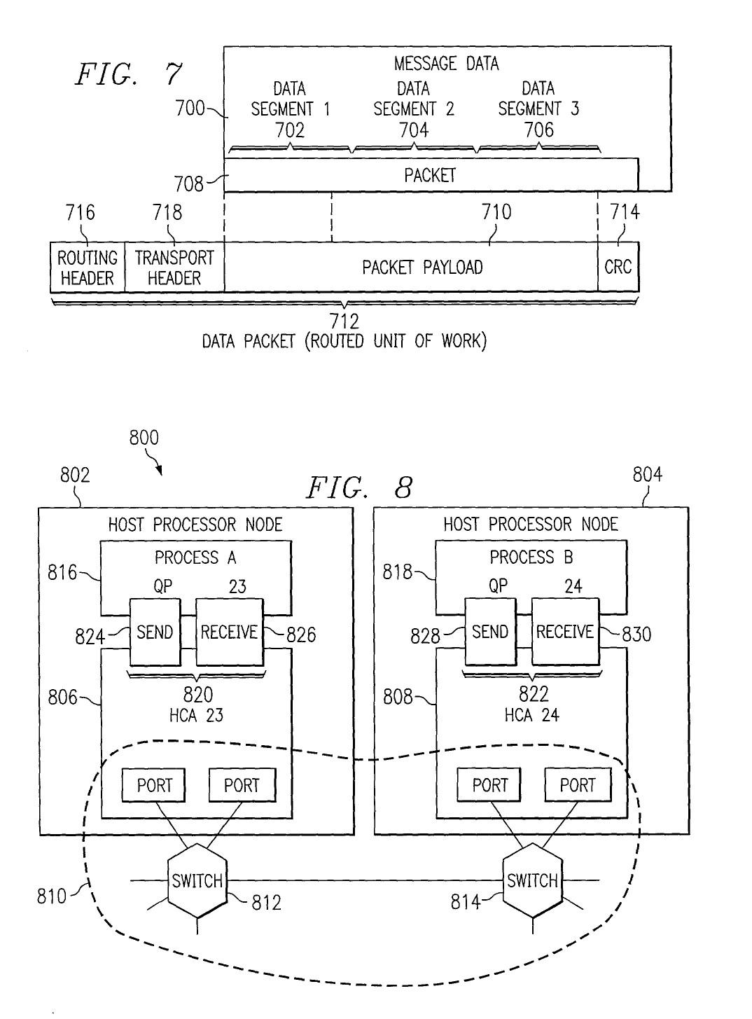

Turning next to FIG. 7, an illustration of a data packet is depicted in accordance with a preferred embodiment of the present invention. A data packet is a unit of information that is routed through the SAN fabric. The data packet is an endnode-to-endnode construct, and is thus created and consumed by endnodes. For packets destined to a channel adapter (either host or target), the data packets are neither generated nor consumed by the switches and routers in the SAN fabric. Instead for data packets that are destined to a channel adapter, switches and routers simply move request packets or acknowledgment packets closer to the ultimate destination, modifying the variant link header fields in the process. Routers, also modify the packet's network header when the packet crosses a subnet boundary. In traversing a subnet, a single packet stays on a single service level.

Message data 700 contains data segment 1 702, data segment 2 704, and data segment 3 706, which are similar to the data segments illustrated in FIG. 4. In this example, these data segments form a packet 708, which is placed into packet payload 710 within data packet 712. Additionally, data packet 712 contains CRC 714, which is used for error checking. Additionally, routing header 716 and transport header 718 are present in data packet 712. Routing header 716 is used to identify source and destination ports for data packet 712. Transport header 718 in this example specifies the destination queue pair for data packet 712. Additionally, transport header 718 also provides information such as the operation code, packet sequence number, and partition for data packet 712.

The operating code identifies whether the packet is the first, last, intermediate, or only packet of a message. The operation code also specifies whether the operation is a send RDMA write, read, or atomic. The packet sequence number is initialized when communication is established and increments each time a queue pair creates a new packet. Ports of an endnode may be configured to be members of one or more possibly overlapping sets called partitions.

In FIG. 8, a portion of a distributed computer system is depicted to illustrate an example request and acknowledgment transaction. The distributed computer system in FIG. 8 includes a host processor node 802 and a host processor node 804. Host processor node 802 includes a host channel adapter 806. Host processor node 804 includes a host channel adapter 808. The distributed computer system in FIG. 8 includes a SAN fabric 810, which includes a switch 812 and a switch 814. The SAN fabric includes a link coupling host channel adapter 806 to switch 812; a link coupling switch 812 to switch 814; and a link coupling host channel adapter 808 to switch 814.

In the example transactions, host processor node 802 includes a client process A. Host processor node 804 includes a client process B. Client process A interacts with host channel adapter hardware 806 through queue pair 23. Client process B interacts with hardware channel adapter hardware 808 through queue pair 24. Queue pairs 23 and 24 are data structures that include a send work queue and a receive work queue.

Process A initiates a message request by posting work queue elements to the send queue of queue pair 23. Such a work queue element is illustrated in FIG. 4. The message request of client process A is referenced by a gather list contained in the send work queue element. Each data segment in the gather list points to part of a virtually contiguous local memory region, which contains a part of the message, such as indicated by data segments 1, 2, and 3, which respectively hold message parts 1, 2, and 3, in FIG. 4.

Hardware in host channel adapter 806 reads the work queue element and segments the message stored in virtual contiguous buffers into data packets, such as the data packet illustrated in FIG. 7. Data packets are routed through the SAN fabric, and for reliable transfer services, are acknowledged by the final destination endnode. If not successfully acknowledged, the data packet is retransmitted by the source endnode. Data packets are generated by source endnodes and consumed by destination endnodes.

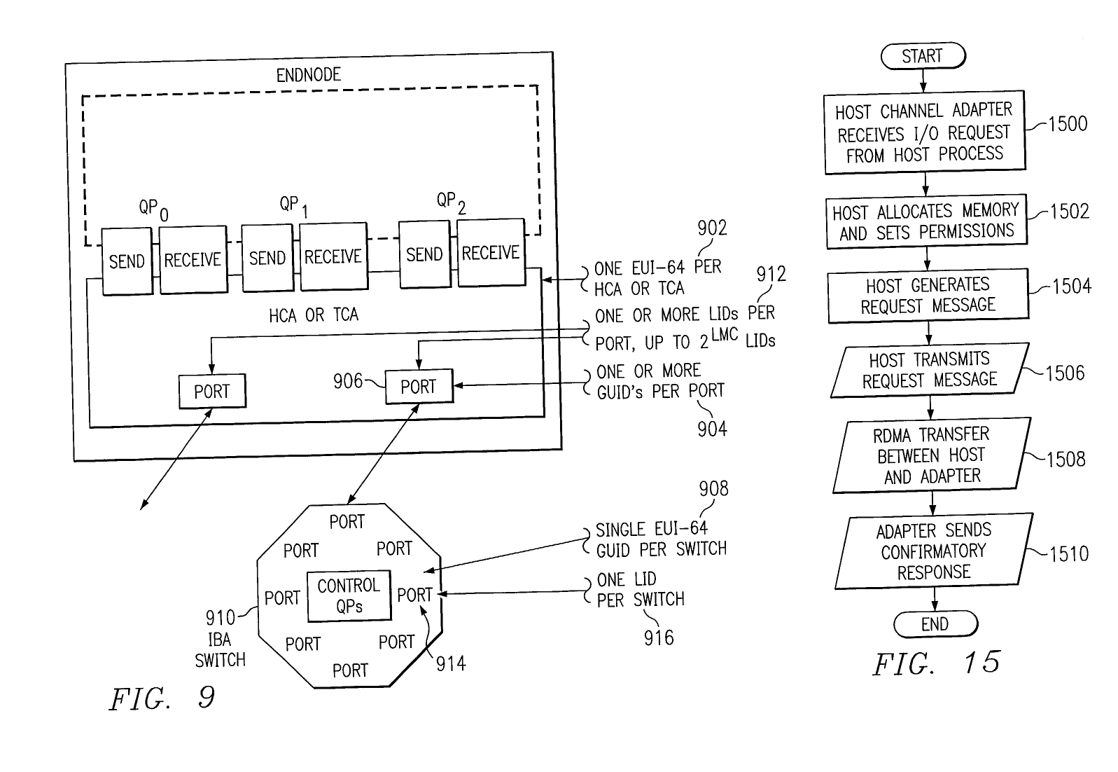

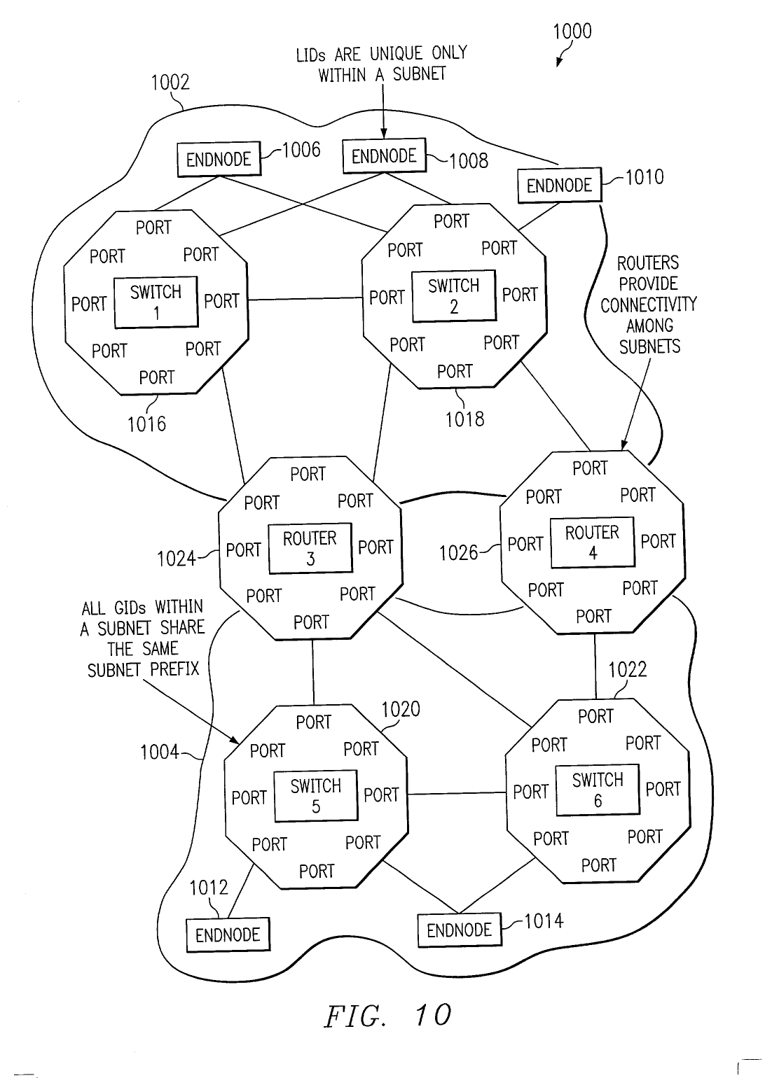

In reference to FIG. 9, a diagram illustrating the network addressing used in a distributed networking system is depicted in accordance with the present invention. A host name provides a logical identification for a host node, such as a host processor node or I/O adapter node. The host name identifies the endpoint for messages such that messages are destined for processes residing on an end node specified by the host name. Thus, there is one host name per node, but a node can have multiple CAs.

A single IEEE assigned 64-bit identifier (EUI-64) 902 is assigned to each component. A component can be a switch, router, or CA.

One or more globally unique ID (GUID) identifiers 904 are assigned per CA port 906. Multiple GUIDs (a.k.a. IP addresses) can be used for several reasons, some of which are illustrated by the following examples. In one embodiment, different IP addresses identify different partitions or services on an end node. In a different embodiment, different IP addresses are used to specify different Quality of Service (QoS) attributes. In yet another embodiment, different IP addresses identify different paths through intra-subnet routes.

One GUID 908 is assigned to a switch 910.

A local ID (LID) refers to a short address ID used to identify a CA port within a single subnet. In one example embodiment, a subnet has up to 2¹⁶ end nodes, switches, and routers, and the LID is accordingly 16 bits. A source LID (SLID) and a destination LID (DLID) are the source and destination LIDs used in a local network header. A single CA port 906 has up to 2^{LMC} LIDs 912 assigned to it. The LMC represents the LID Mask Control field in the CA. A mask is a pattern of bits used to accept or reject bit patterns in another set of data.

Multiple LIDs can be used for several reasons some of which are provided by the following examples. In one embodiment, different LIDs identify different partitions or services in an end node. In another embodiment, different LIDs are used to specify different QoS attributes. In yet a further embodiment, different LIDs specify different paths through the subnet.

A single switch port 914 has one LID 916 associated with it.

A one-to-one correspondence does not necessarily exist between LIDs and GUIDs, because a CA can have more or less LIDs than GUIDs for each port. For CAs with redundant ports and redundant connectivity to multiple SAN fabrics, the CAs can, but are not required to, use the same LID and GUID on each of its ports.

A portion of a distributed computer system in accordance with a preferred embodiment of the present invention is illustrated in FIG. 10. Distributed computer system 1000 includes a subnet 1002 and a subnet 1004. Subnet 1002 includes host processor nodes 1006, 1008, and 1010. Subnet 1004 includes host processor nodes 1012 and 1014. Subnet 1002 includes switches 1016 and 1018. Subnet 1004 includes switches 1020 and 1022.

Routers connect subnets. For example, subnet 1002 is connected to subnet 1004 with routers 1024 and 1026. In one example embodiment, a subnet has up to 216 endnodes, switches, and routers.

A subnet is defined as a group of endnodes and cascaded switches that is managed as a single unit. Typically, a subnet occupies a single geographic or functional area. For example, a single computer system in one room could be defined as a subnet. In one embodiment, the switches in a subnet can perform very fast wormhole or cut-through routing for messages.

A switch within a subnet examines the DLID that is unique within the subnet to permit the switch to quickly and efficiently route incoming message packets. In one embodiment, the switch is a relatively simple circuit, and is typically implemented as a single integrated circuit. A subnet can have hundreds to thousands of endnodes formed by cascaded switches.

As illustrated in FIG. 10, for expansion to much larger systems, subnets are connected with routers, such as routers 1024 and 1026. The router interprets the IP destination ID (e.g., IPv6 destination ID) and routes the IP-like packet.

An example embodiment of a switch is illustrated generally in FIG. 3B. Each I/o path on a switch or router has a port. Generally, a switch can route packets from one port to any other port on the same switch.

Within a subnet, such as subnet 1002 or subnet 1004, a path from a source port to a destination port is determined by the LID of the destination host channel adapter port. Between subnets, a path is determined by the IP address (e.g., IPv6 address) of the destination host channel adapter port and by the LID address of the router port which will be used to reach the destination's subnet.

In one embodiment, the paths used by the request packet and the request packet's corresponding positive acknowledgment (ACK) or negative acknowledgment (NAK) frame are not required to be symmetric. In one embodiment employing oblivious routing, switches select an output port based on the DLID. In one embodiment, a switch uses one set of routing decision criteria for all its input ports. In one example embodiment, the routing decision criteria are contained in one routing table. In an alternative embodiment, a switch employs a separate set of criteria for each input port.

A data transaction in the distributed computer system of the present invention is typically composed of several hardware and software steps. A client process data transport service can be a user-mode or a kernel-mode process. The client process accesses host channel adapter hardware through one or more queue pairs, such as the queue pairs illustrated in FIGS. 3A, 5, and 6. The client process calls an operating-system specific programming interface, which is herein referred to as “verbs.” The software code implementing verbs posts a work queue element to the given queue pair work queue.

There are many possible methods of posting a work queue element and there are many possible work queue element formats, which allow for various cost/performance design points, but which do not affect interoperability. A user process, however, must communicate to verbs in a well-defined manner, and the format and protocols of data transmitted across the SAN fabric must be sufficiently specified to allow devices to interoperate in a heterogeneous vendor environment.

In one embodiment, channel adapter hardware detects work queue element postings and accesses the work queue element. In this embodiment, the channel adapter hardware translates and validates the work queue element's virtual addresses and accesses the data.

An outgoing message is split into one or more data packets. In one embodiment, the channel adapter hardware adds a transport header and a network header to each packet. The transport header includes sequence numbers and other transport information. The network header includes routing information, such as the destination IP address and other network routing information. The link header contains the Destination Local Identifier (DLID) or other local routing information. The appropriate link header is always added to the packet. The appropriate global network header is added to a given packet if the destination endnode resides on a remote subnet.

If a reliable transport service is employed, when a request data packet reaches its destination endnode, acknowledgment data packets are used by the destination endnode to let the request data packet sender know the request data packet was validated and accepted at the destination. Acknowledgement data packets acknowledge one or more valid and accepted request data packets. The requester can have multiple outstanding request data packets before it receives any acknowledgments. In one embodiment, the number of multiple outstanding messages, i.e. Request data packets, is determined when a queue pair is created.

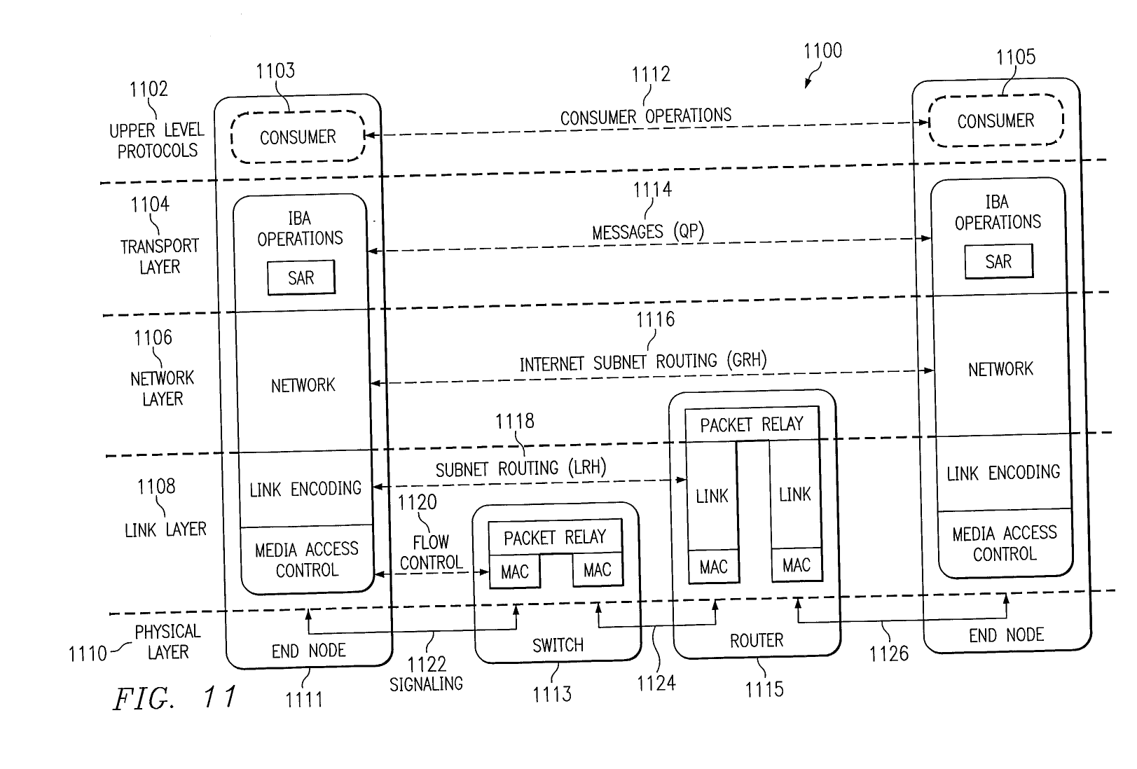

One embodiment of a layered architecture 1100 for implementing the present invention is generally illustrated in diagram form in FIG. 11. The layered architecture diagram of FIG. 11 shows the various layers of data communication paths, and organization of data and control information passed between layers.

Host channel adaptor endnode protocol layers (employed by endnode 1111, for instance) include an upper level protocol 1102 defined by consumer 1103, a transport layer 1104; a network layer 1106, a link layer 1108, and a physical layer 1110. Switch layers (employed by switch 1113, for instance) include link layer 1108 and physical layer 1110. Router layers (employed by router 1115, for instance) include network layer 1106, link layer 1108, and physical layer 1110.

Layered architecture 1100 generally follows an outline of a classical communication stack. With respect to the protocol layers of end node 1111, for example, upper layer protocol 1102 employs verbs to create messages at transport layer 1104. Transport layer 1104 passes messages (1114) to network layer 1106. Network layer 1106 routes packets between network subnets (1116). Link layer 1108 routes packets within a network subnet (1118). Physical layer 1110 sends bits or groups of bits to the physical layers of other devices. Each of the layers is unaware of how the upper or lower layers perform their functionality.

Consumers 1103 and 1105 represent applications or processes that employ the other layers for communicating between endnodes. Transport layer 1104 provides end-to-end message movement. In one embodiment, the transport layer provides four types of transport services as described above which are reliable connection service; reliable datagram service; unreliable datagram service; and raw datagram service. Network layer 1106 performs packet routing through a subnet or multiple subnets to destination endnodes. Link layer 1108 performs flow-controlled, error checked, and prioritized packet delivery across links.

Physical layer 1110 performs technology-dependent bit transmission. Bits or groups of bits are passed between physical layers via links 1122, 1124, and 1126. Links can be implemented with printed circuit copper traces, copper cable, optical cable, or with other suitable links.

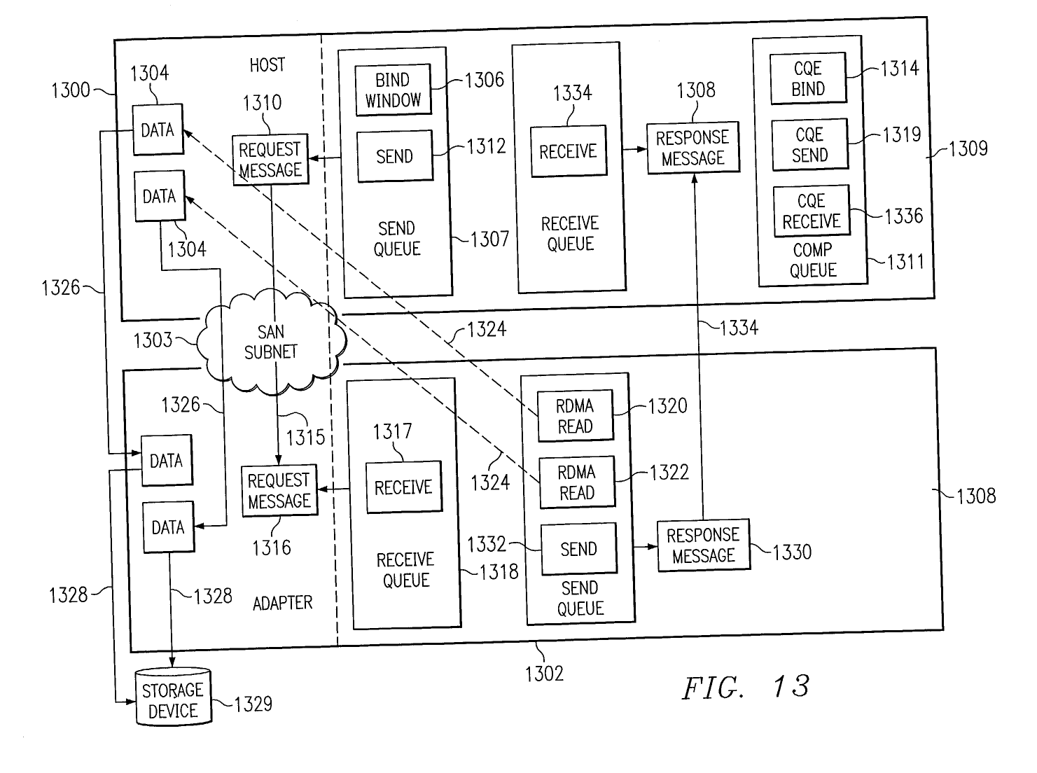

FIG. 12 is a diagram showing the flow of Communication Management packets to establish a connection and exchange private data in a preferred embodiment of the present invention.

The following terms will be used in the descriptions that follow: “Storage Data” is used to designate the data which will be written/read from storage and read/written host memory. “Storage Request” is used to designate the storage command block passed by the device driver to the storage adapter. “Storage Response” is used to designate the storage return block passed by the storage adapter to the device driver.

FIG. 12 illustrates how during the connection establishment process, the adapter uses a connection management protocol REP reply message's private data field to pass back to the device driver the depth of the adapter's Request Pointer Queue. This step is only necessary if the adapter has a variable depth request queue.

During normal operations the device driver will never let the number of outstanding I/O transactions be larger than the adapter's request queue depth. During normal operations the device driver pushes, via a Post Send, the memory attributes of a Storage Request message into the adapter's Request receive queue. The adapter interprets the message and if it is a write to storage, the adapter uses a Read RDMA to read the data from host memory at the location specified in the Request message. The data is then either placed in the media or committed to non-volatile store at the adapter. If the Request message is a read from storage, the adapter reads the data from media or its adapter buffer (which ever the most recent version of the data) and then uses a Write RDMA to write the data into host memory at the location specified in the Request message.

When the data transfers complete, the adapter sends a storage Response message back to the host. The Response message includes a transaction ID, which is used by the host device driver to associate the Response message to the original Request message. The host device driver retrieves the Storage Response message as a (receive) work completion.

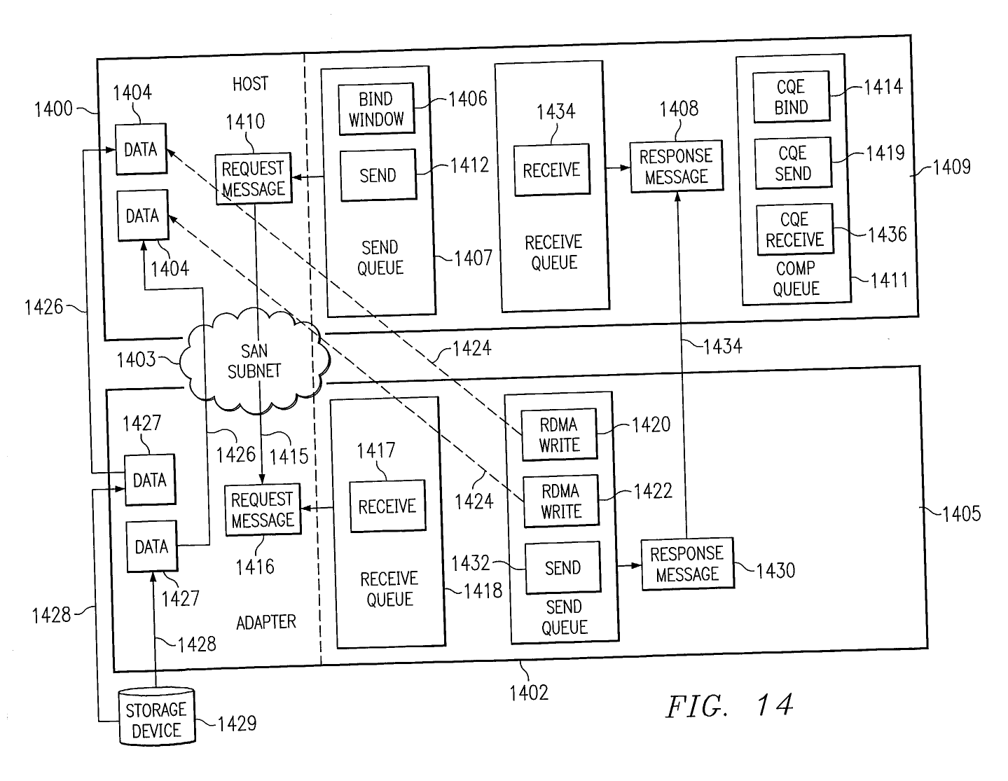

One embodiment of an upper layer protocol used for I/O in a preferred embodiment of the present invention is generally illustrated in diagram form in FIG. 13 and FIG. 14. FIG. 13 describes a method for processing a mixed semantic I/O write to storage operation. FIG. 14 describes a method for processing a mixed semantic I/O read to storage operation.

Referring now to FIG. 13, an upper-layer I/O write protocol between a host 1300 and storage device adapter 1302, connected by SAN subnet 1303, operates as follows:

A process running on host 1300 first stores data 1304, which is to be written to the storage device, in memory. The process then invokes a device driver associated with the storage device adapter, specifying that data 1304 is to be transferred to adapter 1302 for storage.

A “bind memory window” verb 1306 is placed on send queue 1307, so that when “bind memory window” verb 1306 is processed, host channel adapter 1309 will be given permission to access data 1304. Then memory space for a response message 1308 is allocated within host 1300.

A request message 1310 is generated for the transfer. The request message 1310 includes a transaction ID (used to correlate response message, once created, with request message 1310, a command type (I/O write in this case), a list of data segments (including starting virtual address, R_Key, and length), a disk address (e.g., SCSI address, SCSI logical unit number), and a linear block address (i.e., the location where the data will be placed on storage device 1329).

Then a “send” work queue element 1312 is generated, set to point to request message 1310, and placed on send queue 1307. If, at this point, “bind memory window” verb 1306 has been processed, a “bind” completion queue element 1314 is placed on completion queue 1311.

When host channel adapter 1309 processes “send” work queue element 1312, it sends (1315) request message 1310 to adapter 1302. The adapter's target channel adapter 1305 receives the transmitted request message and stores it as request message 1316. After sending request message 1310 to adapter 1302, host channel adapter 1309 will generate a “send” completion queue element 1319 and place it on completion queue 1311.

Adapter 1302 interprets request message 1316 and generates read RDMA work queue elements 1320 and 1322. Work queue elements 1320 and 1322, when interpreted, direct adapter 1302 to send RDMA read requests (1324) to host channel adapter 1300, which then performs (1326) an RDMA transfer of data 1304 into the memory of adapter 1302. Adapter 1302 then transfers (1328) the data into storage device 1329.

At the close of the write transaction, adapter 1302 generates a response message 1330 and an associated “send” work queue element 1332. When “send” work queue element 1332 is interpreted and processed, response message 1330 is transmitted by adapter 1302 to host 1300, where it is stored in location 1308, which was reserved for the response message and was referenced by work queue element 1334. Finally, a “receive” completion queue element 1336 is generated and placed on completion queue 1311, to inform the device driver that the response message has been received.

Referring now to FIG. 14, an upper-layer I/O read protocol between a host 1400 and storage device adapter 1402, connected by SAN subnet 1403, operates as follows:

A process running on host 1400 first reserves a memory space for holding read data 1404. The process then invokes a device driver associated with the storage device adapter, specifying that data from storage device 1429 is to be read into read data memory space 1404.

A “bind memory window” verb 1406 is placed on send queue 1407, so that when “bind memory window” verb 1406 is processed, host channel adapter 1409 will be given permission to access read data memory space 1404. Then memory space for a response message 1408 is allocated within host 1400.

A request message 1410 is generated for the transfer. The request message 1410 includes a transaction ID (used to correlate response message, once created, with request message 1410, a command type (I/O read in this case), a list of data segments (including starting virtual address, R_Key, and length), a disk address (e.g., SCSI address, SCSI logical unit number), and a linear block address (i.e., the location where the data resides on storage device 1429).

Then a “send” work queue element 1412 is generated, set to point to request message 1410, and placed on send queue 1407. If, at this point, “bind memory window” verb 1406 has been processed, a “bind” completion queue element 1414 is placed on completion queue 1411.

When host channel adapter 1409 processes “send” work queue element 1412, it sends (1415) request message 1410 to adapter 1402. The adapter's target channel adapter 1421 receives the transmitted request message and stores it as request message 1416 at the location referenced by receive work queue element 1417. After sending request message 1410 to adapter 1402, host channel adapter 1409 will generate a “send” completion queue element 1419 and place it on completion queue 1411.

Adapter 1402 interprets request message 1416 and generates RDMA write work queue elements 1420 and 1422. Adapter 1402 also loads data 1427 from storage device 1429. Work queue elements 1420 and 1422, when interpreted, direct adapter 1402 to perform (1426) an RDMA transfer of data 1427 into read data memory space 1404.

At the close of the RDMA write transaction, adapter 1402 generates a response message 1430 and an associated “send” work queue element 1432. When “send” work queue element 1432 is interpreted and processed, response message 1430 is transmitted by adapter 1402 to host 1400, where it is stored in location 1408, which was reserved for the response message and was referenced by receive work queue element 1434. Finally, a “receive” completion queue element 1436 is generated and placed on completion queue 1411, to inform the device driver that the I/O read transaction has completed.

FIG. 15 is a flowchart representation of an upper-level mixed semantic I/O protocol in accordance with a preferred embodiment of the present invention. First the host channel adapter receives an input/output request from a process executing on the host (step 1500). The host allocates memory for the transfer (e.g., to hold data to be read and/or a response message from the adapter) and sets the proper permissions to allow a remote direct memory access (RDMA) transfer to take place between the host and adapter (step 1502). Next, the host generates a request message describing the upcoming transfer (step 1504).

The host transmits the request message to the adapter (step 1506). In response, the adapter initiates an RDMA transfer between the host and adapter (to write data to the adapter's storage or to read data from the adapter's storage) (step 1508). Finally, the adapter sends a confirmatory response message to the host to notify the host that a successful RDMA transfer has occurred (step 1510).

It is important to realize that a number of optimizations may be employed to enhance the operation of the present invention as described in embodiment herein described. One such optimization is to reduce the number of confirmatory response messages sent from the adapter to the host by, for instance, limiting the number of responses to one per a given number of transfers. Another is to forgo placing some or all of the completion queue elements on a completion queue.

To further improve performance, the input/output protocol herein described may be supplemented with a resource allocation scheme so as to reduce the workload of any one adapter or storage device. Examples of resource allocation techniques that may be applied to the present invention include, but are not limited to, first-come-first-served resource access by a limited number of hosts to a given adapter, first-come-first-served resource access by a limited number of hosts for a limited time, pre-defined allocation of adapters to hosts, and the like. While not optimizations to the protocol, per se, these resource allocation schemes can make a significant contribution to the overall performance of an input/output system in accordance with the present invention.

The following is a list of additional optimizations to the basic methodology described herein:

1) To support an I/O virtualization policy, the adapter can:

a) Use a managed approach. For example by using a resource management queue pair to manage the number of hosts that are allowed to communicate with the adapter and the specific resources (e.g. queue pairs, read cache, fast write buffer, work queue depth, number of queue pairs, RDMA resources, etc.) assigned to each host. As shown in Table I and Table II the resource management queue pair can send the adapter a matrix of resources allocated to each host global ID. The matrix can be relative as shown in Table I or fixed as shown in Table II. The adapter can retain the information in non-volatile store or require that it be recreated every time the machine is booted.

b) Use an unmanaged approach. For example, by allowing all hosts to access the adapter's resources under a first come, first served lease model. Under this model, a given host obtains adapter resources (e.g. queue pairs, read cache space, fast write buffer space, etc.) for a limited time. After the time expires, the host either must renegotiate or give up the resource for another host to use. The resources and time can be preset or negotiated through the communication management protocol shown in FIG. 12. The private data would consist of a row from Table I or Table II.

TABLE I
I/O Virtualization - Relative Resource
Allocation Mechanism

| GID | | | | | |
|---|---|---|---|---|---|
| (could | Relative Resources | | | | |
| use LID | | | | Fast | |
| or | Which | Number | Read | Write | Other |
| EUI-64 | Service | of Queue | Cache | Buffer | Adapter |
| instead) | Levels | Pairs | Size | Size | Resources |
| xx231 | 1, 2, 3 | 3x | 3x | 3x | . . . |
| xx232 | 1, 2, 3 | 2x | 3x | 1x | . . . |
| xx233 | 1, 2, 3 | 2x | 1x | 3x | . . . |
| xx234 | 2, 3 | 1x | 2x | 2x | . . . |

TABLE II
I/O Virtualization - Fixed Resource Allocation
Mechanism

| GID | | | | | |
|---|---|---|---|---|---|
| (could | Resources | | | | |
| use LID | | | | Fast | |
| or | Which | Number | Read | Write | Other |
| EUI-64 | Service | of Queue | Cache | Buffer | Adapter |
| instead) | Levels | Pairs | Size | Size | Resources |
| xx231 | 1, 2, 3 | 6 | 300 MB | 300 MB | . . . |
| xx232 | 1, 2, 3 | 6 | 300 MB | 100 MB | . . . |
| xx233 | 1, 2, 3 | 6 | 100 MB | 300 MB | . . . |
| xx234 | 2, 3 | 4 | 200 MB | 200 MB | . . . |

2) To support differentiated services policy:

a) An adapter's differentiated service policy defines the resources allocated and event scheduling priorities for each service level supported by the adapter.

b) Resource allocation and scheduling can be performed using one of two methods:

i) As depicted in Table III, to support differentiated service policies, the adapter uses a Relative Adapter Resource Allocation and Scheduling Mechanism. Under this policy each service level is assigned a weight.

Resources are assigned to an service level by weight. Services that have the same service level share the resources assigned to that service level. For example, an adapter has a 1 GByte Fast Write buffer, and 2 service levels, SL1 with a weight of 3× and SL21×. If this adapter supports 2 SL1 connections and 2 SL2 connections, and all 4 connections have been allocated, then each SL1 connection gets 384 MB of Fast Write Buffer and each SL2 connection gets 128 MB of Fast Write Buffer. Similarly, scheduling decisions are made based on service level weights. Services that have the same service level share the scheduling events assigned to that service level.

ii) As depicted in Table IV, to support differentiated service policies, the adapter uses a Fixed Adapter Resource Allocation and Scheduling Mechanism. Under this policy each service level is assigned a fixed number of resources.

A fixed amount of resources are assigned to each service level. Services that have the same service level share the resources assigned to that service level. For example, an adapter has an 800 MByte Fast Write buffer, and 2 service levels, SL1 has 600 MB of space and SL2 has 200 MB of space. If this adapter supports 2 SL1 connections and 2 SL2 connections, and all 4 connections have been allocated, then each SL1 connection gets 300 MB of Fast Write Buffer and each SL2 connection gets 100 MB of Fast Write Buffer.

Scheduling decisions are made based on fixed time (or cycle) allocations. Services that have the same service level share the time (or cycles) spent processing operations on that service level.

c) The differentiated service policy is applied to the adapter through a managed approach. For example by using a resource management queue pair to set and manage the adapter's differentiated service policy. The resource management queue pair can only be accessed by an adapter manager which has the appropriate access control (e.g. P_Key). An adapter management driver having the appropriate access controls can access the resource management queue pair and set the adapter's differentiated service policy. That is, the resource manager sends the adapter a matrix of resources allocated to each service level. The matrix can be relative as shown in Table III or fixed as shown in Table IV (a description of each is provided in the next paragraph). If it is fixed and the adapter resources are over-provisioned, the adapter returns an overprovisioning error response. If no error is encountered, the adapter accepts the differentiated service policy defined by the matrix. The adapter can retain the differentiated service policy in non-volatile-store or require that it be recreated every time the machine is booted.

d) The differentiated service policy defines how adapter resources and event scheduling will be apportioned for that class of service when a communication service is established.

e) At communication service establishment, the adapter assigns local resources (e.g. read cache, fast write buffer, work queue depth) based on the differentiated service policy settings for the service level (from Table III and Table IV) and the service level(s) requested in the communication service establishment process (see FIG. 14:).

f) The class of service is defined by the service level (and/or IP Traffic Class) field.

g) As shown in FIG. 12, the private data portion of the communication management messages can be used to connect more than one queue pair/end-to-end context, each with a different service level.

h) To support differentiated service policies, an adapter can mix the resource allocation policy, such that some resources are allocated on a relative basis and others are allocated on a fixed basis.

i) To support differentiated service policies, resource allocation can be performed statically based on the maximum amount required to support the largest configuration of a specific topology. Alternatively, resource allocation can be performed dynamically to fully assign resources to only those services which are currently in use. The latter is more useful for I/O adapters that follow a resource lease and reservation model. Adapters that do not follow such a model cannot dynamically assign resources without the ability to re-negotiate previously committed resources; additionally, such adapters would also need to statically allocate basic resources (e.g. queue pair space).

TABLE III
Relative Adapter Resource Allocation and
Scheduling Mechanism

| | Resources | | | | |
|---|---|---|---|---|---|
| | | | | Fast | |
| | | | Read | Write | Other |
| Service | Scheduler | Queue | Cache | Buffer | Adapter |
| Level | Setting | Pairs | Size | Size | Resources |
| 1 | 4x | 4x | 3x | 3x | . . . |
| 2 | 3x | 3x | 2x | 3x | . . . |
| 3 | 2x | 3x | 3x | 2x | . . . |
| 4 | 1x | 1x | 1x | 1x | . . . |

TABLE IV
Fixed Adapter Resource Allocation and
Scheduling Mechanism

| | Resources | | | | |
|---|---|---|---|---|---|
| | | | | Fast | |
| | | | Read | Write | Other |
| Service | Scheduler | Queue | Cache | Buffer | Adapter |
| Level | Setting | Pairs | Size | Size | Resources |
| 1 | 4x | 4 | 300 MB | 300 MB | . . . |
| 2 | 3x | 2 | 100 MB | 300 MB | . . . |
| 3 | 2x | 2 | 300 MB | 100 MB | . . . |
| 4 | 1x | 1 | 100 MB | 100 MB | . . . |

3) As shown in Table V, to support a communication group policy, the adapter can:

a) Define the number of queue pairs (with service type for each) and the number of other adapter resources assigned to a given communication group.

b) Use a managed or unmanaged approach to define the resources which are to be associated with a communication group during communication establishment.

i) Under a managed approach the resources which are to be associated with a communication group (see Table V) are preset either through a resource management queue pair or during the manufacturing process. The resource management queue pair sends a communication group matrix to the adapter and the communication management ServiceID associated to the communication group. If the adapter resources are overprovisioned, the adapter returns an overprovisioning error response. If no error is encountered, the adapter accepts the communication group defined by the matrix. The adapter can retain the communication group in non-volatile-store or require that it be recreated every time the machine is booted. An adapter can support multiple communication groups, each is identified by a different communication management ServiceID. During the communication establishment process, the active side uses the communication management ServiceID to select one of the preset communication groups supported by the adapter.

ii) Under an unmanaged approach the resources that are to be associated with a communication group (see Table V) are dynamically negotiated through the communication management protocol shown in FIG. 12. The private data would consist of the contents from Table V, plus the additional Communication Management fields needed for each connection or unreliable datagram service (e.g. Primary Local Port LID).

4) Adapters can support various combinations of resource I/O virtualization, differentiated service, and communication group policies, including:

a) The adapter's resource management queue pair (could be the general service interface queue pair) is used to set: the number of resources assigned to a given service through the communication group; the number of communications groups and types of communication groups to a global ID; and finally the scheduling of adapter events based on service level:

i) The adapter's communication group policy is used to define the number of resources which are to be associated every time a communication establishment process is completed successfully.

ii) The adapter's I/O virtualization policy is used to assign 1 or more communication groups to a specific global ID (or alternatively LID or EUI-64).

iii) The adapter's differentiated services policy is used to just allocate the scheduling settings (not the resources) on the adapter on a per service level basis.

iv) At communication establishment time, the active side requests a communication group. If the adapter determines that sufficient resources are available to service the request and the communication group is assigned to the specific global ID, the adapter will reply with a successful communication management response. Otherwise it will reject the communication management request.

b) Not support communication groups and simply select the smaller of the two settings for a specific resource in Table I and Table III as the maximum resource capacity assigned to a given global ID using the I/O adapter.

i) The adapter's I/O virtualization policy is used to allocate a set of adapter resources to a specific global ID (or alternatively LID or EUI-64).

ii) The adapter's differentiated services policy is used to allocate adapter resources and scheduler settings on a per service level basis.

iii) Finally, at communication establishment time, the active side requests one or more connections or unreliable datagram queue pairs. The adapter compares the resources requested to those currently available as a result of applying the I/O virtualization policy and the differentiated services policy. If the adapter determines that sufficient resources are available to service the request and source of the request has an entry in the I/O virtualization table, the adapter will reply with a successful communication management response. Otherwise it will reject the communication management request.

c) Many other combinations of these three policies can be formed under the present invention.

TABLE V
Communication Group Adapter Resource Allocation
Mechanism
Resources allocated to the communication group

| | Queue | | | | Fast | |
|---|---|---|---|---|---|---|
| | Pairs | Send | Receive | Read | Write | Other |
| Service | and | Queue | Queue | Cache | Buffer | Adapter |
| Levels | Type | Depth | Depth | Size | Size | Resources |
| 1 | 1,RC | 1200 | 1200 | 400 MB | 400 MB | . . . |
| 2 | 1,RC | 600 | 600 | 400 MB | 400 MB | . . . |
| 3 | 1,UD | 200 | 200 | 100 MB | 100 MB | . . . |

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. For example, although the illustrations show communications from one node to another node, the mechanisms of the present invention may be implemented between different processes on the same node. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method, operable in a data processing system having a host, for performing an input/output transaction, comprising:
sending a request message to an adapter; and
performing, under the control of the adapter, a remote direct memory access transfer through a system area network.

2. The method of claim 1, wherein the remote direct memory access includes the adapter's reading memory from the host.

3. The method of claim 1, wherein the remote direct memory access includes the adapter's writing to memory of the host.

4. The method of claim 1, wherein the request message includes remote direct memory access transfer parameters.

5. The method of claim 4, wherein the remote direct memory access transfer parameters include at least one of a transaction ID, a list of data segments, an identification of a storage device, and an address on a storage device.

6. The method of claim 1, further comprising:
receiving a confirmatory response from the adapter.

7. A method, operable in a data processing system having an adapter, for performing an input/output transaction, comprising:
receiving a request message from a host; and
performing a remote direct memory access transfer with the host through a system area network.

8. The method of claim 7, wherein the remote direct memory access includes reading memory from the host.

9. The method of claim 8, further comprising:
writing data read from the memory to a storage device.

10. The method of claim 7, wherein the remote direct memory access includes writing to memory of the host.

11. The method of claim 10, further comprising:
reading from a storage device data to be written to the memory.

12. The method of claim 7, wherein the request message includes remote direct memory access transfer parameters.

13. The method of claim 12, wherein the remote direct memory access transfer parameters include at least one of a transaction ID, a list of data segments, an identification of a storage device, and an address on a storage device.

14. The method of claim 7, further comprising:
sending a confirmatory response to the host.

15. A computer program product in a computer readable medium for execution in a data processing system having a host, comprising instructions for:
sending a request message to an adapter; and
performing, under the control of the adapter, a remote direct memory access transfer through a system area network.

16. The computer program product of claim 15, wherein the remote direct memory access includes the adapter's reading memory from the host.

17. The computer program product of claim 15, wherein the remote direct memory access includes the adapter's writing to memory of the host.

18. The computer program product of claim 15, wherein the request message includes remote direct memory access transfer parameters.

19. The computer program product of claim 18, wherein the remote direct memory access transfer parameters include at least one of a transaction ID, a list of data segments, an identification of a storage device, and an address on a storage device.

20. The computer program product of claim 15, comprising additional instructions for:
receiving a confirmatory response from the adapter.

21. A computer program product in a computer readable medium for execution in a data processing system having an adapter, comprising:
receiving a request message from a host; and
performing a remote direct memory access transfer with the host through a system area network.

22. The computer program product of claim 21, wherein the remote direct memory access includes reading memory from the host.

23. The computer program product of claim 22, comprising additional instructions for:
writing data read from the memory to a storage device.

24. The computer program product of claim 21, wherein the remote direct memory access includes writing to memory of the host.

25. The computer program product of claim 24, comprising additional instructions for:
reading from a storage device data to be written to the memory.

26. The computer program product of claim 21, wherein the request message includes remote direct memory access transfer parameters.

27. The computer program product of claim 26, wherein the remote direct memory access transfer parameters include at least one of a transaction ID, a list of data segments, an identification of a storage device, and an address on a storage device.

28. The computer program product of claim 21, further comprising:
sending a confirmatory response to the host.

29. A data processing system comprising:
a bus system;
a processing unit connected to the bus system, wherein the processing unit includes at least one processor;
a memory;
a host channel adapter in connection with a system area network; and
a set of instructions in the memory,
wherein the processing unit executes the set of instructions to perform the acts of:
sending a request message, using the host channel adapter, to an input/output device adapter; and
performing, under the control of the input/output device adapter, a remote direct memory access transfer through a system area network.

30. The data processing system of claim 29, wherein the remote direct memory access includes the input/output device adapter's reading the memory.

31. The data processing system of claim 29, wherein the remote direct memory access includes the input/output device adapter's writing to the memory.

32. The data processing system of claim 29, wherein the request message includes remote direct memory access transfer parameters.

33. The data processing system of claim 32, wherein the remote direct memory access transfer parameters include at least one of a transaction ID, a list of data segments, an identification of a storage device, and an address on a storage device.

34. The data processing system of claim 29, wherein the processing unit performs the additional act of:
receiving a confirmatory response from the input/output device adapter.

35. A data processing system comprising:
a bus system;
a processing unit connected to the bus system, wherein the processing unit includes at least one processor;
a first memory;
a target channel adapter in connection with a system area network; and
a set of instructions in the first memory,
wherein the processing unit executes the set of instructions to perform the acts of:
receiving a request message from a host with the target channel adapter; and
performing a remote direct memory access transfer with the host through the system area network.

36. The data processing system of claim 35, wherein the remote direct memory access includes reading a second memory from the host.

37. The data processing system of claim 36, wherein the processing unit performs the additional act of:
writing data read from the second memory to a storage device.

38. The data processing system of claim 35, wherein the remote direct memory access includes writing to a second memory of the host.

39. The data processing system of claim 38, wherein the processing unit performs the additional act of: reading from a storage device data to be written to the second memory.

40. The data processing system of claim 35, wherein the request message includes remote direct memory access transfer parameters.

41. The data processing system of claim 40, wherein the remote direct memory access transfer parameters include at least one of a transaction ID, a list of data segments, an identification of a storage device, and an address on a storage device.

42. The data processing system of claim 35, wherein the processing unit performs the additional act of:
sending a confirmatory response to the host.
